(19) United States
(12) Patent Application Publication
(10) Pub. No.: US 2019/0318535 A1
(43) Pub. Date: Oct. 17, 2019

(54) Display data processing method and apparatus

(71) Applicant: CloudMinds (Shenzhen) Robotics Systems Co., Ltd., Shenzhen (CN)

(72) Inventors: Kai Wang, Beijing (CN); Shiguo Lian, Beijing (CN); Luowei Wang, Beijing (CN)

(73) Assignee: CloudMinds (Shenzhen) Robotics Systems Co., Ltd., Shenzhen (CN)

(21) Appl. No.: 16/455,250

(22) Filed: Jun. 27, 2019

Related U.S. Application Data
(63) Continuation of application No. PCT/CN2016/112398, filed on Dec. 27, 2016.

(51) Int. Cl. G06T 17/00; G06T 15/20; G06K 9/00

(52) U.S. Cl. CPC G06T 17/00; G06T 2210/61; G06K 9/00671; G06T 15/20

(57) ABSTRACT

The embodiment of the present application discloses a display data processing method and apparatus, and relates to the technical field of image processing. Display data including global environmental information may be generated to represent a whole situation of an environment where a user is located to background service personnel, so that the background service personnel may globally understand the environment where the user is located. The method includes: collecting scene information of a local scene in an environment where a user is located; detecting a predetermined target in the local scene in the scene information, and generating visual data, wherein the visual data include the predetermined target; and superposing the visual data with an environmental model of the environment, and generating display data of a specified perspective, the display data include the environmental model and the predetermined target. The embodiment of the present application is applied to display data processing.

### CROSS-REFERENCE TO RELATED APPLICATION

The present application is a continuation application under 35 U.S.C. § 120 of PCT application No. PCT/CN2016/112398 filed on Dec. 27, 2016, the contents of which are incorporated herein by reference.

### FIELD OF THE INVENTION

The embodiment of the present application relates to the field of image processing technology, and in particular, to a display data processing method and apparatus.

### BACKGROUND OF THE INVENTION

In a service system such as video-based manual navigation and the like, a front end device carried by a user may be used for collecting a local scene in an environment where the user is located, and the scene information of the collected local scene is presented to background service personnel in a back end client in the form of an image, a location and the like, the background service personnel judges the current orientation, posture and environmental information of the user according to the image, the location and other information presented by the client, and then performs the operation such as monitoring and sending instructions to the user or a robot according to the environmental information.

However, in this manner, limited by factors such as the collection perspective of a front end image and the display mode of the background, the background service personnel cannot comprehensively understand the environment where the user is located, thus affecting the judgment thereof on the front end user and the surrounding information.

### SUMMARY OF THE INVENTION

The embodiment of the present application provides a display data processing method and apparatus, in which display data including global environmental information may be generated to represent a whole situation of an environment where a user is located to background service personnel, so that the background service personnel may globally understand the environment where the user is located, thereby improving the accuracy of the background service personnel to judge the user information

In a first aspect, a display data processing method is provided, including:
collecting scene information of a local scene in an environment where a user is located;
detecting a predetermined target in the local scene in the scene information, and generating visual data, wherein the visual data include the predetermined target; and
superposing the visual data with an environmental model of the environment, and generating display data of a specified perspective, the display data include the environmental model and the predetermined target.

In a second aspect, a display data processing apparatus is provided, including:
a collection unit, configured to collect scene information of a local scene in an environment where a user is located;
a processing unit, configured to detect a predetermined target in the local scene in the scene information collected by the collection unit, and generate visual data, wherein the visual data include the predetermined target; and
the processing unit is further configured to superpose the visual data with an environmental model of the environment, and generate display data of a specified perspective, the display data include the environmental model and the predetermined target.

In a third aspect, an electronic device is provided, comprising: a memory, a communication interface and a processor, the memory and the communication interface are coupled to the processor, the memory is configured to store a computer executive code, the processor is configured to execute the computer executive code to control the execution of the above display data processing method, and the communication interface is configured to perform data transmission between the display data processing apparatus and an external device.

In a fourth aspect, a computer storage medium is provided for storing a computer software instruction used by the display data processing apparatus and including a program code designed to execute the above display data processing method.

In a fifth aspect, a computer program product is provided, which is capable of being directly loaded in an internal memory of a computer and contains a software code, and the computer program may implement the above display data processing method after being loaded and executed by the computer.

In the above solution, the display data processing apparatus collects the scene information of the local scene in the environment where the user is located; detects the predetermined target in the local scene in the scene information, and generates the visual data, wherein the visual data include the predetermined target; and superposes the visual data with the environmental model of the environment, and generates the display data, the display data include the environmental model and the predetermined target. Compared with the prior art, since the display data include the visual data indicating the predetermined target in the scene information of the local scene in the environment where the user is located and the environmental model of the environment where the user is located, when the display data are displayed on a background client, since the display data contain global environment information, so that the whole situation of the environment where the user is located may be presented to the background service personnel, and the background service personnel may globally understand the environment where the user is located according to the display data, thereby improving the accuracy of the background service personnel to judge the user information.

### BRIEF DESCRIPTION OF THE DRAWINGS

To illustrate technical solutions of the embodiments of the present application more clearly, a brief introduction on the drawings which are needed in the description of the embodiments or the prior art is given below. Apparently, the drawings in the description below are merely some of the embodiments of the present application, based on which other drawings may be obtained by those of ordinary skill in the art without any creative effort.

FIG. 1 is a structure diagram of a communication system provided by an embodiment of the present application;

FIG. 2 is a flow diagram of a display data processing method provided by an embodiment of the present application;

FIG. 3 is a virtual model diagram of a first person user perspective provided by an embodiment of the present application;

FIG. 4 is a virtual model diagram of a first person observation perspective provided by an embodiment of the present application;

FIG. 5 is a virtual model diagram of a third person fixed perspective provided by an embodiment of the present application;

FIG. 6A-6C are virtual model diagrams of a third person free perspective provided by an embodiment of the present application;

FIG. 7 is a structure diagram of a display data processing apparatus provided by an embodiment of the present application;

FIG. 8A is a structure diagram of an electronic device provided by another embodiment of the present application;

FIG. 8B is a structure diagram of an electronic device provided by yet another embodiment of the present application.

### DETAILED DESCRIPTION OF THE EMBODIMENTS

A system architecture and a service scene described in the embodiment of the present application are for the purpose of more clearly illustrating the technical solutions of the embodiment of the present application, and do not constitute a limitation of the technical solutions provided by the embodiment of the present application. Those of ordinary skill in the art may know that the technical solutions provided by the embodiment of the present application are also applicable to similar technical problems with the evolution of the system architecture and the appearance of new service scenes.

It should be noted that, in the embodiment of the present application, the words “exemplary” or “for example” or the like are used for meaning examples, example illustration or illustration. Any embodiment or design solution described as “exemplary” or “for example” in the embodiment of the present application should not be construed as be more preferred or advantageous than other embodiments or design solutions. Properly speaking, the words “exemplary” or “for example” or the like are intended to present related concepts in a specific manner.

It should be noted that, in the embodiment of the present application, “of (English: of)”, “corresponding (English: corresponding, relevant)” and “corresponding (English: corresponding)” may sometimes be mixed for use. It should be noted that, when the difference is not emphasized, the meanings to be expressed are the same. In addition, it may be understood that “A and/or B” in the embodiment of the present application at least includes three cases of A, B and A and B.

The basic principle of the present application is to simultaneously superimpose the visual data of a user himself and a predetermined target in the scene information of a local scene in an environment where the user is located and an environmental model of the environment where the user is located in display data, so that when the display data are displayed on a background client, since the display data include global environmental information, the whole situation of the environment where the user is located may be represented to the background service personnel, so that the background service personnel may globally understand the environment where the user is located according to the display data, and accuracy of the background service personnel to judge the user information is improved.

A specific embodiment of the present application may be applied to the following communication system, the system shown in FIG. 1 includes a front end device 11 carried by the user, a background server 12 and a background client 13, wherein the front end device 11 in the present solution is configured to collect environmental data of the environment where the user is located, and the scene information of the local scene in the environment where the user is located. The display data processing apparatus provided by the embodiment of the present application is applied to the background server 12 to serve as the background server 12 itself or a functional entity configured thereon. The background client 13 is configured to receive and display the display data to the background service personnel and perform human-computer interaction with the background service personnel, for example, receiving the operation of the background service personnel to generate a control instruction or an interactive data stream of the front end device 11 or the background server 12 so as to achieve the behavior guidance of the user carrying the front end device 11, such as navigation, peripheral information prompting, and the like.

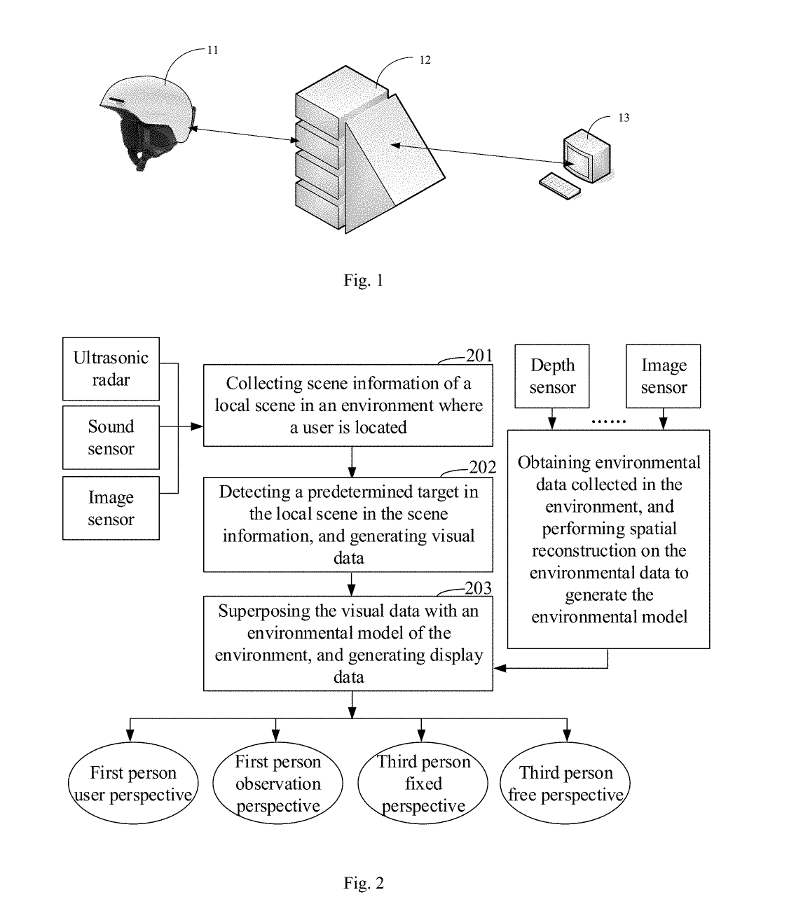

A specific embodiment of the present application provides a display data processing method, applied to the above communication system, as shown in FIG. 2, including:

201. collecting scene information of a local scene in an environment where a user is located.

Wherein, in order to achieve the instantaneity of user behavior guidance, the step 201 is performed in real time in an online manner generally, one implementation manner of the step 201 is to collect the scene information of the local scene in the environment where the user is located by using at least one sensor, and the sensor is an image sensor, an ultrasonic radar or a sound sensor. The scene information herein may be an image and sound; and an orientation, a distance and the like of an object around the user corresponding to the image and the sound.

202. detecting a predetermined target in the local scene in the scene information and generating visual data.

Wherein, the visual data include the predetermined target. In the step 202, the scene information may be specifically analyzed by using machine intelligence and the visual technology to judge the predetermined target in the local scene, such as a person, an object or the like in the local scene. The predetermined target at least includes one or more of the following items: a user location, a user gesture, a specific target around the user, a travel route of the user and the like, the visual data may be characters and/or a physical model, and exemplarily, both of the characters and the physical model may be 3D graphics.

203. superimposing the visual data with an environmental model of the environment and generating display data.

Wherein, the display data may include the environmental model and the predetermined target obtained in the step 202. In 203, the environmental model may be a 3D model of the environment, wherein the data size contained in the environment is large and the environment in which the user enters is uncertain according to the human will, so the environment needs to be learned offline, and the specific method for obtaining the environmental model includes: obtaining the environmental data collected in the environment, and performing spatial reconstruction on the environmental data to generate the environmental model. Specifically, the environmental data in the environment may be collected by using at least one sensor, and the sensor is a depth sensor, a laser radar or an image sensor or the like.

In order to further improve the accuracy of the background service personnel to judge the user information, display data of different perspectives may be represented on the background client of the background service personnel through the virtual display technology. Specifically, before the step 203, the method further includes: receiving a perspective instruction sent by the client (the background client). The step 203 specifically includes: superimposing the visual data with the environmental model of the environment and generating the display data of a specified perspective, including superimposing the visual data with the environmental model of the environment and generating the display data of the specified perspective according to a perspective instruction.

The specified perspective includes any of the following: a first person user perspective, a first person observation perspective, a first person free perspective, a first person panoramic perspective, a third person fixed perspective and a third person free perspective; and when the specified perspective includes any of the first person observation perspective, the third person fixed perspective and the third person free perspective, the display data contains a virtual user model.

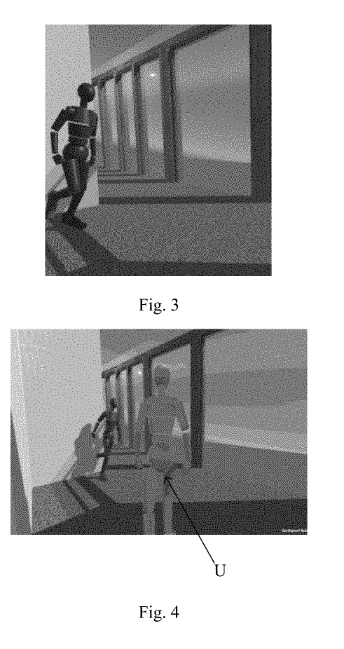

Exemplarily, referring to FIG. 3, when the display data are generated from the first person user perspective, the image seen by the background service personnel on the client is a virtual model seen from a front end user perspective, and the display data include the environmental model and the visual data in the step 202.

Exemplarily, referring to FIG. 4, when the display data are generated from the first person observation perspective, the image seen by the background service personnel on the client is a virtual model in which a virtual camera is located behind the user and synchronously changes with the user perspective, the virtual model includes the environmental model and the visual data and the virtual user model in the step 202, for example, a virtual user model U contained in FIG. 4. When the display data are generated from the first person free perspective, the image seen by the background service personnel on the client is that a virtual camera moves with the user, but the observation perspective may be converted around the user. The virtual model includes the environmental model and the visual data in the step 202. The difference with the first person observation perspective is that the first person observation perspective may only observe the image synchronized with the user perspective, and the first person free perspective may be converted around the user in the observation perspective. When the display data are generated from the first person panoramic perspective, the image seen by the background service personnel on the client is that the virtual camera moves with the user, but the observation perspective is 360 degrees around the user. The virtual model includes the environmental model and the visual data in the step 202. The difference with the first person observation perspective is that the first person observation perspective may only observe the image synchronized with the user perspective, and the observation perspective of the first person panoramic perspective may be 360 degrees around the user.

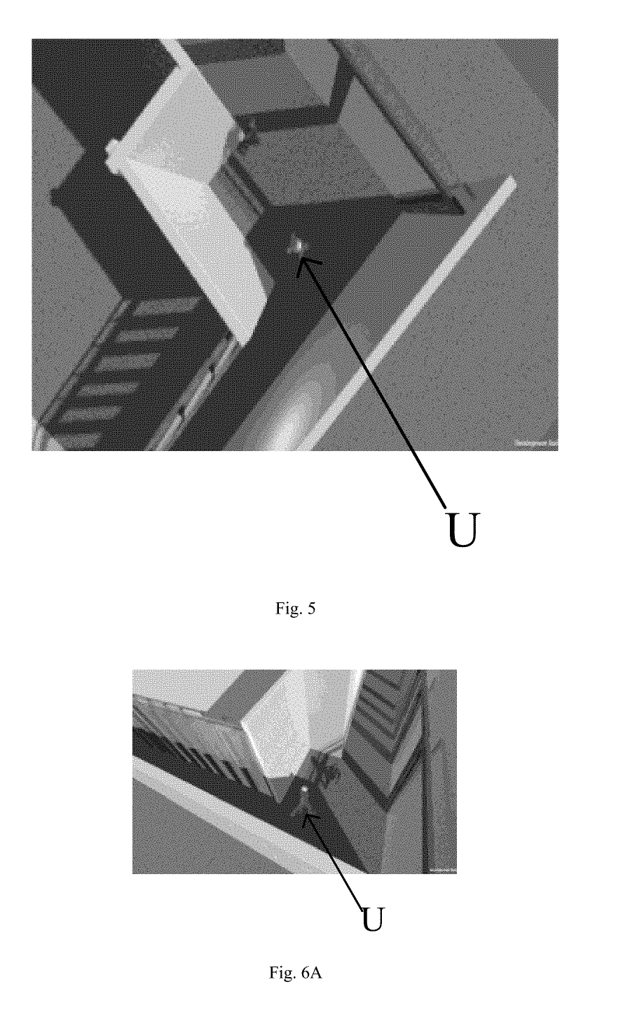

Exemplarily, referring to FIG. 5, when the display data are generated from the third person fixed perspective, the image seen by the background service personnel on the client is the virtual model in which the virtual camera is located on any fixed side of the user and moves with the user, exemplary, as shown in FIG. 5, it is a virtual model reconstructed by overlooking from (side) upper side of the user, the virtual model includes the environmental model and the visual data and the virtual user model in the step 202, for example, a virtual user model U contained in FIG. 5. The difference between FIG. 4 and FIG. 5 is that FIG. 4 takes into account the user perspective, and FIG. 5 is a virtual machine perspective.

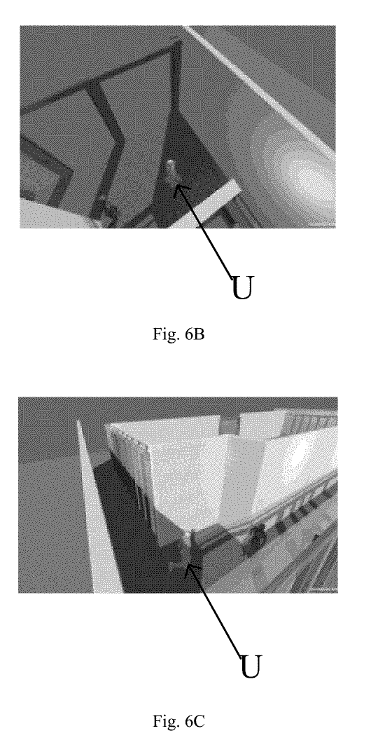

Exemplarily, referring to FIG. 6A-6C, when the display data are generated from the third person free perspective, the image seen by the background service personnel on the client is that the initial location of the virtual camera is at a fixed location (for example, the upper side of the user) around the user and may randomly change the angle according to a perspective instruction input by the background service personnel, for example, the instruction generated by an operation of a input device (mouse, keyboard, joystick and the like), wherein three angles are respectively shown in FIG. 6A-6C, the information around the user may be seen from any angle, for example, as shown in FIG. 6A-6C, it is a virtual model reconstructed by overlooking from (side) upper side of the user, the virtual model includes the environmental model and the visual data and the virtual user model in the step 202, for example, a virtual user model U contained in FIG. 6A-6C.

In the above solution, the display data processing device collects the scene information of the local scene in the environment where the user is located; detects the predetermined target in the local scene in the scene information and generates the visual data; superimposes the visual data with the environmental model of the environment and generates the display data. Compared with the prior art, since the display data includes both the visual data indicating the predetermined target in the scene information of the local scene in the environment where the user is located and the environmental model of the environment where the user is located, when the display data is displayed on the background client, since the display data contains global environment information, the whole situation of the environment where the user is located can be presented to the background service personnel. The background service personnel can globally understand the environment in which the user is located according to the display data, and improve the accuracy of the background service personnel in judging the user information.

It may be understood that the display data processing apparatus implements the functions provided by the above embodiments through hardware structures and/or software modules contained therein. Those skilled in the art will readily appreciate that the present application may be implemented by hardware or a combination of hardware and computer software in combination with the units and algorithm steps of the various examples described in the embodiments disclosed herein. Whether a certain function is performed in the form of hardware or driving the hardware via the computer software is determined by specific applications and design constraint conditions of the technical solutions. Those skilled in the art may implement the described functions by using different methods for each specific application, but this implementation should not be considered beyond the scope of the present application.

The embodiment of the present application may divide the function modules of the display data processing apparatus according to the above method example, for example, the function modules may be divided according to the functions, and two or more functions may also be integrated into one processing module. The above integrated module may be implemented in the form of hardware and may also be implemented in the form of a software function module. It should be noted that the division of the modules in the embodiment of the present application is schematic and is only a logical function division, and other division manners may be provided during the actual implementation.

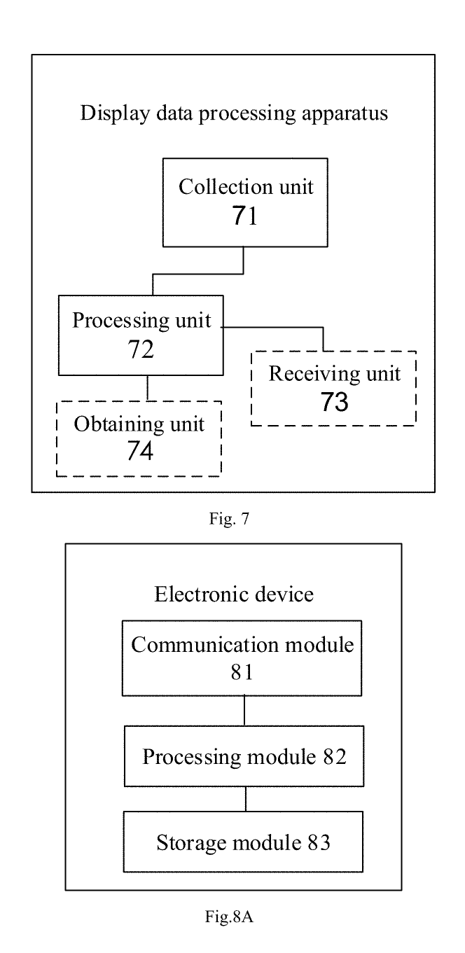

In the case that the function modules are divided according to the functions, FIG. 7 shows a possible structural schematic diagram of the display data processing apparatus involved in the above embodiment, the display data processing apparatus includes: a collection unit 71 and a processing unit 72. The collection unit 71 is configured to collect scene information of a local scene in an environment where a user is located; the processing unit 72 is configured to detect a predetermined target in the local scene in the scene information collected by the collection unit 71, and generate visual data, wherein the visual data include the predetermined target, superpose the visual data with an environmental model of the environment, and generate display data, wherein the display data include the environmental model and the predetermined target; optionally, the display data processing apparatus further includes: a receiving unit 73, configured to receive a perspective instruction sent by a client. The processing unit 72 is specifically configured to superpose the visual data with the environmental model of the environment, and generate display data of a specified perspective according to the perspective instruction. The specified perspective includes any one of the following: a first person user perspective, a first person observation perspective, a third person fixed perspective, and a third person free perspective; wherein when the specified perspective includes any one of the first person observation perspective, the third person fixed perspective and the third person free perspective, the display data include a virtual user model. The visual data include characters and/or a physical model. The predetermined target includes at least one or more of the following items: a user location, a user gesture, a specific target around the user, and a travel route of the user.

In addition, optionally, the display data processing apparatus further includes: an obtaining unit 74, configured to obtain environmental data collected in the environment, the processing unit is further configured to perform spatial reconstruction on the environmental data obtained by the obtaining unit to generate the environmental model. The obtaining unit 74 is specifically configured to collect the environmental data in the environment by using at least one sensor, and the sensor is a depth sensor, a laser radar or an image sensor. The collection unit 71 is specifically configured to collect the scene information of the local scene in the environment where the user is located by using at least one sensor, and the sensor is an image sensor, an ultrasonic radar or a sound sensor. All the related contents of the steps involved in the foregoing method embodiment may be quoted to the function descriptions of the corresponding function modules, and thus details are not described herein again.

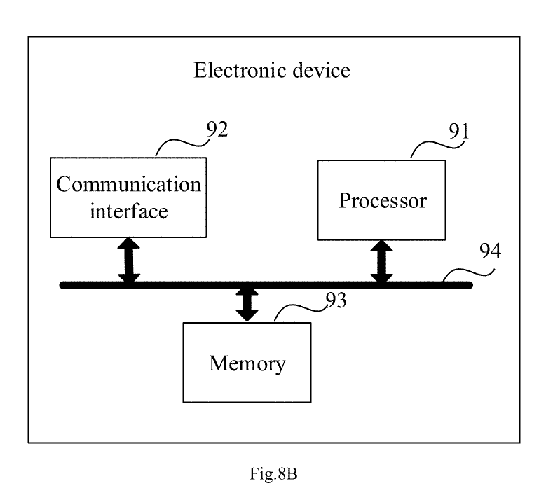

FIG. 8A shows a possible structural schematic diagram of an electronic device involved in the embodiment of the present application. The electronic device includes a communication module 81 and a processing module 82. The processing module 82 is configured to perform control and management on display data processing actions, for example, the processing module 82 is configured to support the display data processing apparatus to execute the method executed by the processing unit 72. The communication module 81 is configured to support the data transmission between the display data processing apparatus and other device and to implement the method executed by the collection unit 71, the receiving unit 73 and the obtaining unit 74. The electronic device may further include a storage module 83, configured to store a program code and data of the display data processing apparatus, for example, cache the method executed by the processing unit 72.

The processing module 82 may be a may be a processor or a controller, for example, may be a central processing unit (Central Processing Unit, CPU), a general purpose processor, a digital signal processor (Digital Signal Processor, DSP), an application-specific integrated circuit (Application-Specific Integrated Circuit, ASIC), a field programmable gate array (Field Programmable Gate Array, FPGA) or other programmable logic devices, transistor logic devices, hardware components or any combinations thereof. The processing module may implement or execute logic boxes, modules and circuits of various examples described in combination with the contents disclosed by the present application. The processor may also be a combination for implementing a computing function, for example, a combination including one or more microprocessors, a combination of a DSP and a microprocessor, and the like. The communication module 81 may be a transceiver, a transceiver circuit, a communication interface or the like. The storage module 83 may be a memory.

When the processing module 82 is the processor, the communication module 81 is the communication interface, and the storage module 83 is the memory, the electronic device involved in the embodiment of the present application may be the display data processing apparatus as shown in FIG. 8B.

As shown in FIG. 8B, the electronic device includes a processor 91, a communication interface 92, a memory 93 and a bus 94. The memory 93 and the communication interface 92 are coupled to the processor 91 through the bus 94; the bus 904 may be a peripheral component interconnect (Peripheral Component Interconnect, PCI) bus or an extended industry standard architecture (Extended Industry Standard Architecture, EISA) bus or the like. The bus may be divided into an address bus, a data bus, a control bus and the like. For the ease of representation, the bus is only expressed by a thick line in FIG. 8B, but it does not mean that there is only one bus or one type of bus.

The steps of the method or algorithm described in combination with the contents disclosed by the present application may be implemented in the form of hardware and may also be implemented by a processor executing software instructions. The software instruction may be composed of corresponding software modules, the software modules may be stored in a random access memory (Random Access Memory, RAM), a flash memory, a read only memory (Read Only Memory, ROM), an erasable programmable read-only memory (Erasable Programmable ROM, EPROM), an electrically erasable programmable read-only memory (Electrically EPROM, EEPROM), a register, a hard disk, a mobile hard disk, a CD-ROM (CD-ROM) or any other form of storage medium known in the art. An exemplary storage medium is coupled to the processor, so that the processor may read information from and write information to the storage medium. Of course, the storage medium may also be a constituent part of the processor. The processor and the storage medium may be located in an ASIC. Additionally, the ASIC may be located in a core network interface device. Of course, the processor and the storage medium may also exist as discrete components in the core network interface device.

Those skilled in the art should be aware that, in one or more examples described above, the functions described in the present application may be implemented by hardware, software, firmware, or any combination thereof. When implemented by the software, these functions may be stored in a computer readable medium or transmitted as one or more instructions or codes on the computer readable medium. The computer readable medium includes a computer storage medium and a communication medium, wherein the communication medium includes any medium that may conveniently transfer the computer program from one place to another. The storage medium may be any available medium that may be accessed by a general purpose or special purpose computer.

The objects, technical solutions and beneficial effects of the present application have been further illustrated in detail by the above specific embodiments. It should be understood that the foregoing descriptions are merely specific embodiments of the present application, but the protection scope of the present application is not limited thereto. Any modifications, equivalent substitutions and improvement and the like made on the basis of the technical solutions of the present application shall fall within the protection scope of the present application.

1. A display data processing method, comprising:
collecting scene information of a local scene in an environment where a user is located;
detecting a predetermined target in the local scene in the scene information, and generating visual data, wherein the visual data include the predetermined target; and
superposing the visual data with an environmental model of the environment, and generating display data, the display data include the environmental model and the predetermined target.

2. The method according to claim 1, wherein,
the method further comprises: receiving a perspective instruction sent by a client; and
the superposing the visual data with an environmental model of the environment and generating display data comprises: superposing the visual data with the environmental model of the environment, and generating the display data of the specified perspective according to the perspective instruction.

3. The method according to claim 2, wherein,
the specified perspective comprises any of the following: a first person user perspective, a first person observation perspective, a first person free perspective, a first person panoramic perspective, a third person fixed perspective and a third person free perspective; and
wherein, when the specified perspective comprises any of the first person observation perspective, the third person fixed perspective and the third person free perspective, the display data contains a virtual user model.

4. The method according to claim 1, wherein the method further comprises:
obtaining environmental data collected in the environment, and performing spatial reconstruction on the environmental data to generate the environmental model.

5. The method according to claim 4, wherein the obtaining environmental data collected in the environment comprises: collecting the environmental data in the environment by using at least one sensor, and the sensor is a depth sensor, a laser radar or an image sensor.

6. The method according to claim 1, wherein the collecting scene information of a local scene in an environment where a user is located comprises: collecting the scene information of the local scene in the environment where the user is located by using at least one sensor, and the sensor is an image sensor, an ultrasonic radar or a sound sensor.

7. The method according to claim 1, wherein the visual data are characters and/or a physical model.

8. The method according to claim 1, wherein the predetermined target at least comprises one or more of the following items: a user location, a user gesture, a specific target around the user, a travel route of the user.

9. An electronic device, comprising: a memory, a communication interface and a processor, the memory and the communication interface are coupled to the processor, the memory is configured to store a computer executive code, the processor is configured to execute the computer executive code to control the execution of a display data processing method, and the communication interface is configured to perform data transmission between a display data processing apparatus and an external device, wherein the display data processing method includes:
collecting scene information of a local scene in an environment where a user is located;
detecting a predetermined target in the local scene in the scene information, and generating visual data, wherein the visual data include the predetermined target; and
superposing the visual data with an environmental model of the environment, and generating display data, the display data include the environmental model and the predetermined target.

10. A computer storage medium, for storing a computer software instruction used by a display data processing apparatus and comprising a program code designed to execute a display data processing method including:
collecting scene information of a local scene in an environment where a user is located;
detecting a predetermined target in the local scene in the scene information, and generating visual data, wherein the visual data include the predetermined target; and
superposing the visual data with an environmental model of the environment, and generating display data, the display data include the environmental model and the predetermined target.
